(19) United States
(12) Patent Application Publication
(10) Pub. No.: US 2006/0044790 A1
(43) Pub. Date: Mar. 2, 2006

(54) Candy cane menorah

(76) Inventor: John Crawley, Port Washington, NY (US)

Correspondence Address: WILLIAM COLLARD;COLLARD & ROE, P.C., 1077 NORTHERN BOULEVARD, ROSLYN, NY, 11576, US

(21) Appl. No.: 10/925,276

(22) Filed: Aug. 24, 2004

(51) Int. Cl. F21S 8/00

(52) U.S. Cl. 362/153

(57) ABSTRACT

A Chanukah menorah having a base, a power source and a plurality of illumination members detachably secured to the base in a substantially vertical orientation. The illumination members include a translucent fixture having the shape and appearance of a candy cane. Light sources in the fixture are coupled to the power supply and provide illumination. Switches are coupled to the power supply and light sources for independent illumination of individual members. A projection may be provided to represent the menorah Shamash. The menorah may be operated manually via the switches or automatically via a timer coupled thereto.

### BACKGROUND OF THE INVENTION

1. Field of the Invention

The invention relates to a Chanukah menorah comprising individually lighted members having the shape and appearance of candy canes.

2. The Prior Art

The menorah is one of the oldest symbols of the Jewish faith. A traditional menorah is a multi-branched candelabrum. The traditional Chanukah menorah or Hanukiya has nine candle holders. Eight candles symbolize the eight nights of Chanukah, commemorating a reported miracle wherein one day's worth of oil for a menorah lasted for eight days. The ninth candle, called the Shamash, is used to light the other eight candles.

Modern menorot come in a wide variety of shapes, sizes and styles, including menorot designed for burning candles, menorot designed for burning oil and menorot having electric powered lights. The candles or lights of the Chanukah menorah are customarily lit from left to right, with the number of candles or lights illuminated corresponding to the respective night of Chanukah, i.e. three candles or lights are illuminated on the third night of Chanukah.

A candy cane is a stick of hard candy in the shape of a rod having a top portion which is curved to resemble a walking stick. Candy canes are available in an assortment of flavors, colors, patterns and sizes. A traditional candy cane comprises a peppermint flavored candy having red and white coloring and a striped pattern. Candy canes, both actual and stylized, are a widely-recognized symbol of the Christmas season.

### SUMMARY OF THE INVENTION

It is therefore an object of this invention to provide a Chanukah menorah comprising a base and eight illuminated members having the shape and appearance of candy canes.

It is a further object of-this invention to provide a Chanukah menorah wherein means are provided for individual illumination of eight members having the shape and appearance of candy canes.

It is a further object of this invention to provide a Chanukah menorah wherein eight members having the shape and appearance of candy canes are detachably secured to a base wherein the base may be used as a candle holder menorah.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a perspective view of a Chanukah menorah;

FIG. 2 shows a rear view of a Chanukah menorah coupled to a timer; and

FIG. 3 shows side view of an illumination member for a Chanukah menorah.

### DETAILED DESCRIPTION OF THE DRAWINGS

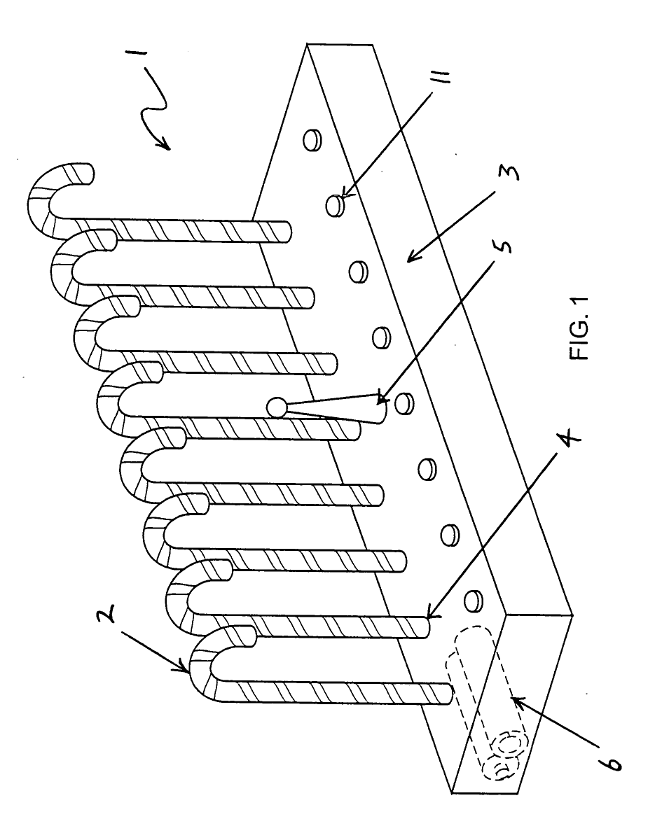

FIG. 1 shows a Chanukah menorah 1 having a plurality of illumination members 2 secured to base 3 in a substantially vertical orientation. Base 3 is made from a substantially rigid material, for example metal, plastic or wood and is formed so as to provide a stable base for Chanukah menorah 1 which is not easily susceptible to tipping over.

Illumination members 2 may be detachably secured to base 3 such that illumination members 2 are easily removed from base 3 to facilitate repair and/or replacement of illumination members 2 or a component thereof.

Illumination members 2 are secured in individual mounting slots 4 which are provided in base 3. When illumination members 2 are detached from base 3, mounting slots 4 may be used to house ordinary candles.

Chanukah menorah 1 may have a projection 5 detachably secured to base 3 in a substantially vertical orientation. Projection 5 represents the Shamash of a traditional menorah. As with mounting slots 4 for illumination members 2, a cavity wherein projection 5 is mounted may be used to house an ordinary candle when projection 5 is removed from base 3.

Chanukah menorah 1 may comprise eight illumination members 2 and one projection 5.

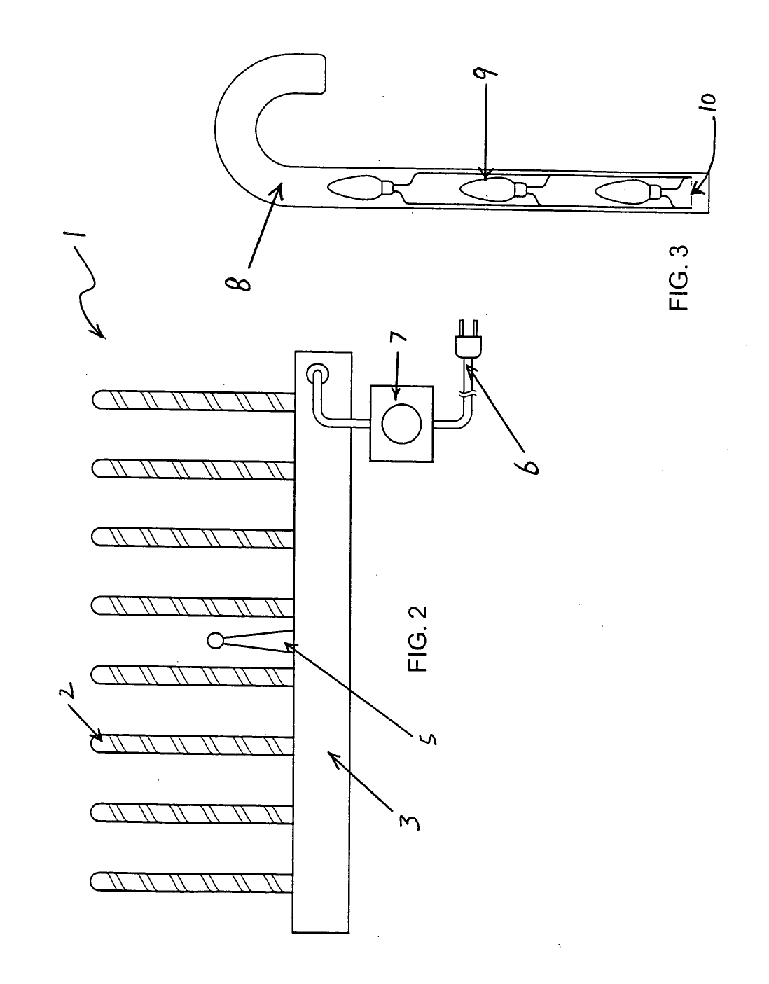

Chanukah menorah 1 has a power source 6 for illuminating illumination members 2. Power source 6 may comprise batteries, as shown in FIG. 1 or a line voltage supplied from a household outlet as shown in FIG. 2. Batteries 6 may be housed in base 3. Additionally, a timer 7 may be coupled to power source 6 for lighting illumination members 2 at a preselected time.

Illumination member 2 has a translucent, rod-shaped fixture 8 with a curved upper portion as shown in FIG. 3. Fixture 8 has the shape and appearance of a candy cane. Fixture 8 may be provided with red and white coloring to resemble a candy cane. Fixture 8 may additionally or alternatively be provided with a striped pattern to resemble a candy cane.

One or more light sources 9 are disposed within fixture 8. Light sources 9 illuminate illumination member 2. Light sources 9 may comprise, for example, incandescent light bulbs, neon light bulbs, light emitting diodes, or similar sources of visible light.

A contact element 10 is located at a bottom portion of fixture 8. Contact element 8 is electrically coupled to power source 6 and to light source 9 such that current may flow from power source 6 to light source 9 thereby illuminating illumination member 2.

Chanukah menorah 1 has switches 11 which are electrically coupled to power source 6, light source 9 and contact element 10. Switches 11 may be coupled to light sources 9 in individual illumination members 2 such that each illumination member 2 may be illuminated or lighted independently of each other illumination member 2. Switches 11 may comprise button or toggle switches disposed on base 3 in an area in proximity to an associated illumination member 2. Detachable projection 5 may be used to activate and/or deactivate switches 11 symbolizing the lighting of candles on a traditional menorah with the Shamash. Additionally, switches 11 may be configured so that they are activated and/or deactivated by pressing down on a corresponding illumination member 2.

Accordingly, while several embodiments of the present invention have been shown and described, it is obvious that many changes and modifications may be made thereunto without departing from the spirit and scope of the invention.

What is claimed is:

1. A Chanukah menorah comprising:
(a) a base;
(b) a power source; and
(c) a plurality of illumination members detachably secured to said base in a substantially vertical orientation, each illumination member comprising:
(i) a translucent rod-shaped fixture having a curved upper portion, wherein said fixture has an appearance of a candy cane;
(ii) one or more light sources disposed within said fixture; and
(iii) a contact element disposed at a bottom portion of said translucent rod-shaped fixture and electrically coupled to said power source and said one or more light sources, wherein said contact element permits a current from said power source to illuminate said one or more light sources.

2. The Chanukah menorah according to claim 1 further comprising a projection detachably secured to said base in a substantially vertical orientation.

3. The Chanukah menorah according to claim 1, further comprising a plurality of switches electrically coupled to said contact element, said one or more light sources and said power source, wherein each of said plurality of switches corresponds to an associated illumination member and allows independent illumination of each of said illumination members.

4. The Chanukah menorah according to claim 3, wherein said switches are activated by pressing down on said translucent rod-shaped fixture.

5. The Chanukah menorah according to claim 1, wherein said plurality of illumination members comprises eight illumination members.

6. The Chanukah menorah according to claim 1, wherein said power source comprises a line voltage.

7. The Chanukah menorah according to claim 1, wherein said power source comprises a battery.

8. The Chanukah menorah according to claim 7, wherein said battery is housed within said base.

9. The Chanukah menorah according to claim 1, further comprising an adjustable timer electrically coupled to said power source.

10. The Chanukah menorah according to claim 1, wherein said illumination members have a striped pattern.

11. The Chanukah menorah according to claim 1, wherein said illumination members have a red and white coloring.
